(19) United States
(12) Patent Application Publication
(10) Pub. No.: US 2024/0054109 A1
(43) Pub. Date: Feb. 15, 2024

(54) DYNAMIC FILE BASED PUBLISH-SUBSCRIBE METHOD AND SYSTEM

(71) Applicant: SYNCED APPS TECHNOLOGIES LTD., Ramat Gan (IL)

(72) Inventor: ITAI ARBEL, TEL AVIV (IL)

(21) Appl. No.: 18/213,908

(22) Filed: Jun. 26, 2023

Related U.S. Application Data
(60) Provisional application No. 63/396,982, filed on Aug. 11, 2022.

(51) Int. Cl. G06F 16/182; G06F 16/16

(52) U.S. Cl. CPC G06F 16/184; G06F 16/1824; G06F 16/164

(57) ABSTRACT

Controlling data read operations by performing at a first point in time a first read operation to read any portion of a file, determining a time interval based on the read portion, and performing, responsive to the time interval having elapsed from the first point in time, a second read operation to read any portion of the file.

### FIELD

The invention relates to the field of communication technology in general, and in particular to utilizing files to implement the publish subscribe pattern for near-real-time applications.

### BACKGROUND

Socket connections (also called persistent connections), that provide two-way communication links between two programs running on the network, are known in the art. A server can support multiple clients by binding many sockets to the same port. Each client needs to establish a connection with the server, using the relevant port and once the connection is established the client and the server can continuously send and receive messages to and from each other using the sockets allocated for that specific connection channel.

An open connection is required to perform real-time bi-directional communication between clients and servers. The open connection is faster for frequent data exchanges and communications overhead is saved by leaving the connection open rather than opening and closing a session for each request. The open connection can also be used with application programming interface (API) to enable servers to push data to clients, in addition to the client polling the server for information.

Keeping the connection open consumes resources on the server. For example, a socket, which is a limited resource per port, needs to be assigned to each specific client and once assigned cannot be used by other clients. In addition, the open connection requires maintenance. The server needs to keep current and past state information and periodically send Transmission Control Protocol (TCP) keep-alive messages. The cost of a service that provides an open connection may include additional fees for maintaining the open connection, and therefore may be more expensive than a service that does not keep the connection open.

The Hypertext Transfer Protocol (HTTP) which is the foundation of data communication for the World Wide Web, uses persistent connections in distributed collaborative applications. Cloud provider, (e.g., AWS, Azure), provide an API (WebSocket) that maintains a persistent connection between connected clients and a server to enable real-time message communication. The payment model for this service may include fees associated with the connection itself (in addition to fees per message).

### SUMMARY

There is provided in accordance with an embodiment of the invention a method for controlling data read operations. The method includes performing at a first point in time a first read operation to read any portion of a file stored on a data storage device, determining a time interval based on the read portion, and performing, responsive to the time interval having elapsed from the first point in time, a second read operation to read any portion of the file.

Additionally, in accordance with an embodiment of the invention, the read portion comprises a formula for computing the time interval between a predefined minimum value and a predefined maximum value, and the determining step includes computing the time interval using the formula.

Moreover, in accordance with an embodiment of the invention, wherein the determining step further comprises detecting a trigger and reducing the time interval to a predefined minimum value.

Furthermore, in accordance with an embodiment of the invention, the performing and determining steps are implemented by an application operated by a user, and the trigger is a detectable action performed by the user, the action is any of opening the application, selecting a specific activity in the application, changing a focus of the application, and performing a gesture detectable by the application.

Still further, in accordance with an embodiment of the invention, the performing step includes generating a name of the file to read in the second read, where the data storage device stores a number of copies of the file, each copy with a different name and the generating step generates the name of a specific copy of the file.

Additionally, in accordance with an embodiment of the invention, the generating step further includes creating a random number between 0 and the number of copies, the number of copies taken from the read portion, and using the random number in the generating step wherein a name of each copy includes a unique number identifying the specific copy.

Moreover, in accordance with an embodiment of the invention, the method includes generating a random number between 0 and an evaluation factor number provided in the read portion and activating an application programming interface (API) if the random number equals a predefined value, where a number of times the API is activated in a predefined period of time is used to estimate a number of required copies.

There is provided in accordance with an embodiment of the invention a system that includes a network file storage device to store a number of copies of a file, each copy with a different name and a client implemented on at least one processor and memory, where the processor is configured to perform at a first point in time a first read operation to read any portion of one of the copies of the number of copies of the file, determine a time interval based on the read portion and perform, responsive to the time interval having elapsed from the first point in time, a second read operation to read any portion of one of the copies of the number of copies of the file.

Additionally, in accordance with an embodiment of the invention, the read portion includes a formula for computing the time interval between a predefined minimum value and a predefined maximum value, and the determining step includes computing the time interval using the formula.

Moreover, in accordance with an embodiment of the invention, the processor is further configured to detect a trigger and reduce the time interval to a predefined minimum value.

Furthermore, in accordance with an embodiment of the invention, the client is associated to an application operated by a user, and the trigger is a detectable action performed by the user such opening the application, selecting a specific activity in the application, changing a focus of the application, and performing a gesture detectable by the application.

Still further, in accordance with an embodiment of the invention, the processor is further configured to generate a name of the file to read in the second read using the read portion.

Additionally, in accordance with an embodiment of the invention, a name of each copy includes a unique number identifying the specific copy and the processor is further configured to create a random number between 0 and the number of copies, the number of copies taken from the read portion, and use the random number to generate the name.

Moreover, in accordance with an embodiment of the invention, the processor is further configured to generate a random number between 0 and an evaluation factor number provided in the read portion and activate an application programming interface (API) if the random number equals a predefined value, where a number of times the API is activated in a predefined period of time is used to estimate the number of required copies.

### BRIEF DESCRIPTION OF THE DRAWINGS

The invention will now be described in relation to certain examples and embodiments thereof with reference to the following illustrative drawing figures so that it may be more fully understood. In the drawings:

FIG. 1 is a schematic illustration of a dynamic file-based publish-subscribe system, constructed and operative in accordance with an embodiment of the invention;

FIG. 2 is a schematic illustration of the server of dynamic file-based publish-subscribe system of FIG. 1, constructed and operative in accordance with an embodiment of the invention;

FIG. 3 is a schematic illustration of a flow that may be implemented by the server of FIG. 2 to handle messages, in accordance with an embodiment of the invention;

FIG. 4 is a schematic illustration of a flow that may be implemented by the server of FIG. 2 to handle messages to evaluate the number of active users, in accordance with an embodiment of the invention;

FIG. 5 is a schematic illustration of a flow that may be implemented by the server of FIG. 2 to ensure the security of the files;

FIG. 6 is a schematic illustration the client of dynamic file-based publish-subscribe system of FIG. 1, constructed and operative in accordance with an embodiment of the invention;

FIG. 7 is a schematic illustration of a flow that may be implemented by the client of FIG. 6 to control the read rate and the time interval between consecutive reads in accordance with an embodiment of the invention; and

FIG. 8 is a schematic illustration of a flow that may be implemented by the client of FIG. 6 to inform the server about the subscription state, in accordance with an embodiment of the invention.

It will be appreciated that for simplicity and clarity of illustration, elements shown in the drawing figures have not necessarily been drawn to scale. For example, the dimensions of some of the elements may be exaggerated relative to other elements for clarity. Further, where considered appropriate, reference numerals may be repeated among the drawing figures to indicate the same or analogous elements.

### DETAILED DESCRIPTION

In the following description, various aspects of the invention will be described. For purposes of explanation, specific configurations and details are set forth in order to provide a thorough understanding of the invention. However, it will also be apparent to one skilled in the art that the invention may be practiced without the specific details presented herein. Furthermore, well known features may be omitted or simplified in order not to obscure the invention.

Many applications, running on the internet, do not need real-time communication and may provide the needed functionality when a message is delivered after a delay. Such applications may include interactions with various smart TV application over the internet that provide means to participate in polls and quizzes, to play, to provide predictions, to shop etc.

Other applications that do not require real-time communication may include game events, interaction with live content on mobile devices and on the WEB. Even various messaging applications such as chat email and various notification services may function properly using a near-real time communication method where the client has access to the messages a few seconds after they were created.

Embodiments of the invention provide an alternative cheaper communication method for near-real-time applications, utilizing files to implement the publish subscribe pattern for near-real-time applications (instead of a broker used in typical publish subscribe implementations). According to an embodiment of the invention, the server may use a file to which it may write the messages to be delivered to the clients and any additional information needed for assisting in controlling the read rate of the clients. The clients may read the file (or any portion of it), extract the messages, and dynamically adjust the read rate according to the additional information. The client may slow down the read rate when there are a few messages and may increase the read rate when there are a lot of messages or when an indication that a burst of messages is expected to arrive appears in the additional information.

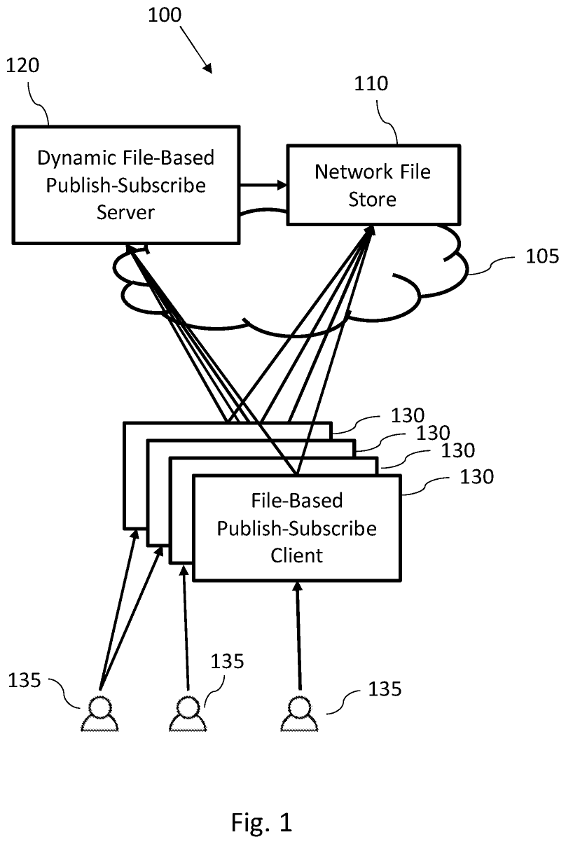

FIG. 1, to which reference is now made, is a schematic illustration of a dynamic file-based publish-subscribe system 100, constructed and operative in accordance with an embodiment of the invention. Dynamic file-based publish-subscribe system 100 a network file store 110 a dynamic file-based publish-subscribe server 120 (referred herein as server 120) and a plurality of file-based publish-subscribe clients 130 (referred herein as clients 130) installed on devices operated by users 135 all communicating over a network 105.

Network 105 may be any network connecting computing devices such as the internet, an intranet and the like.

Network file store 110 may store multiple files on network 105 and may give access to the stored files to server 120 and to a plurality of clients 130. Server 120 may write content (that may include various parameters and messages) to a file and may store it in network file store 110. Multiple clients 130, each installed on a device of an end user 135 (e.g., a smart TV, a computing device such as a laptop or a tablet, a smart phone, a remote control, and the like) may read the file, receive the messages and adjust its read rate based on the received content.

The communication between client 130 and server 120 may start with a handshake (the process of negotiation through the exchange of information at the start of the communication, before full communication begins) that may include exchange of information related to the file-based publish-subscribe subscription. After completing the handshake, server 120 may write messages into a file and store it to network file store 110 (instead of sending them to multiple clients 130 over multiple open connections). Server 120 may keep track of the number of active subscribers and maintain an adequate number of files in network file store 110 to support all clients 130 since one file can support a limited number of concurrent clients 130.

Each client 130 may periodically read one of the files from network file store 110 and get its content. The content may include any number of messages (including zero) and additional parameters for assisting in controlling the read operation. The client may perform a read operation in a variable rate and the time interval between reads may change. Client 130 may adjust the time interval between consecutive read operations based on the content of file provided by server 120 and based on client's own logic. Client 130 may implement various schemes for determining the time interval between read operations which are described herein below. Cloud file store 110 may be any system operating in any network and any cloud that may support create, read, update, and delete operations on files. Examples of possible systems that can be used as network file store 110 are AWS cloud file storage, Google Filestore and AWS S3 buckets.

The file may be in any file format such as JavaScript Object Notation (JSON), Extensible Markup Language (XML) etc., and may include and a list of messages and information related to the functionality of dynamic file-based publish-subscribe system 100 referred to as metadata and described herein below. The file may be empty (i.e., with no messages and no metadata), may include only metadata, only messages or both metadata and messages.

The metadata may include information needed to enable and assist in controlling the read operation and information needed to control and manage network file store 110. The information may include parameters for reading and opening the file, controlling the read rate, providing information needed for controlling the number of files and the like.

In one embodiment, the information related to the read rate may include a minimum time interval between consecutive read operations of the client, a maximum time interval between consecutive read operations of the client and an increment/decrement step the client may add/remove (the final rate bounded by the maximum/minimum time interval). The information may also include a flag instructing the client to resume to the minimum time interval or to the maximum time interval.

For example, client 130 may be configured to read the file with a minimum time interval of 2 seconds between consecutive reads and may increase the time interval between consecutive reads by 1 second as long as there are no new messages in the file (the time interval may be bounded by a maximum value). In this case, client 130 may perform a read operation after 2 seconds, then a consecutive read operation after 3 seconds, and the next one after 4 seconds and so on until reaching the maximum time interval (e.g., 20 seconds) and keep reading the file each maximum time interval. When the file contains a new message, client 130 may decrease the time interval to a minimum value (e.g., 2 seconds).

In another embodiment, the information related to the read rate may include a minimum time interval, a function, and a period to apply the function. The function may be a linear function, an exponent function, or any other function that may increase/decrease the time between read operations. Examples of functions that can be used are mX+b. aX²+b, a(b)^{X}, lan(X)+c, log(X)+c where X is the number of the current iteration inside a defined period. Using these types of functions, the server may control the read rate of the client (e.g., change it in a linear fashion, or in an exponent fashion, or interchangeably use the relevant function according to application needs).

For example, when using the X² method, the time interval in seconds between consecutive reads performed by client 130 may be 1, 4, 9 . . . and so on until a maximum value. When using a function such as lan(X)+2 the time interval in seconds between consecutive reads performed by client 130 may be 2, 2.69, 3.09 and so on until a maximum value.

In another embodiment, the information related to the read rate may include different parameters related to different states of the client. For example, for a state where user 135 is active (i.e. user 135 performs gestures such as scrolling, moving the focus, writing and the like) use a linear function (e.g., aX+b) with specific values of minimum and maximum time intervals) and for a state that the client is not active use a polynomial function (e.g., X²) with other values of minimum and maximum time intervals. The information related to the read operation may include information related to security such as new authentication keys for opening the file after they are changed.

The information related to the file management operation may include an evaluation factor to assist in evaluating the number of clients 130 and the number of files in network file store 110 that are currently handled by server 120. The evaluation factor may be used by client 130 to control the decision whether to send a message indicating an active user 135 to server 120.

Each message in the list may include, in addition to the message content a message identifier and a time stamp.

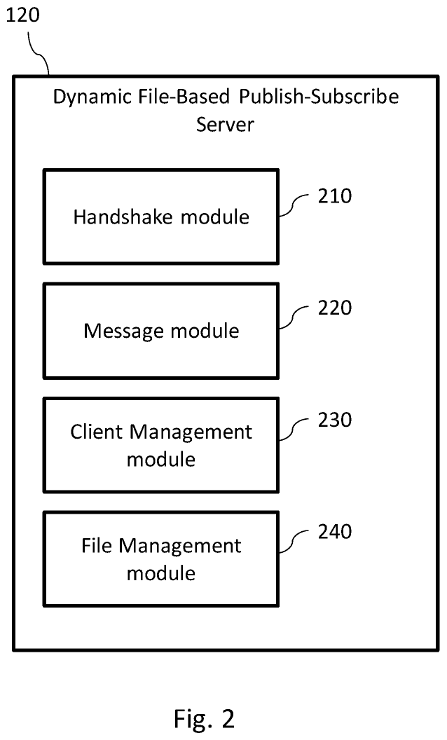

FIG. 2, to which reference is now made, is a schematic illustration of dynamic file-based publish-subscribe server 120 constructed and operative in accordance with an embodiment of the invention. Server 120 may be implemented in a computer software embodied in a non-transitory, computer-readable medium or in a computer hardware having a computer processor and a computer memory. Server 120 may be connected to any cloud system or may be part of a cloud operated by any cloud provider. Server 120 may comprise various modules configured to perform its functionality.

In one embodiment, server 120 comprises a handshake module 210, a message module 220, a client management module 230 and a file management module 240.

Handshake module 210 may be configured to receive requests from clients 130 requesting to subscribe to a specific message stream and to send information needed for client 130 to start reading the file containing the specific messages. During the subscription period server 120 may provide information related to the subscription control itself, in addition to the messages in the file itself.

Handshake module 210 may provide a file name prefix that may be used by the client to create a name of a file to be used in the read operation. Handshake module 210 may provide a first authentication key, a read frequency, an evaluation factor (to assist the server in evaluating the number of active users 135) the number of files currently handled by server 120 and any other piece of information needed by client 130 to read the relevant files from the server in the desired initial rate.

Message module 220 may be configured to manage the messages in the file which may include adding new messages and deleting old ones when needed.

In one embodiment message module 220 may create a new file with old and new messages using for example an external module (e.g., Redis Cache) that may keep messages in memory and write relevant messages to the file every configurable time (e.g., 2, 3, 5, 10 seconds).

In another embodiment message module 220 may append new messages one after the other in the file and may delete old messages from the file after a configurable time which is referred herein as a generation. Message module 220 may keep a message in the files for a predefined period to increase the chance that all clients 130 will get it. The generation may be configured as a constant value or may depend on other parameters such as the minimum and/or maximum time interval between consecutive read operations.

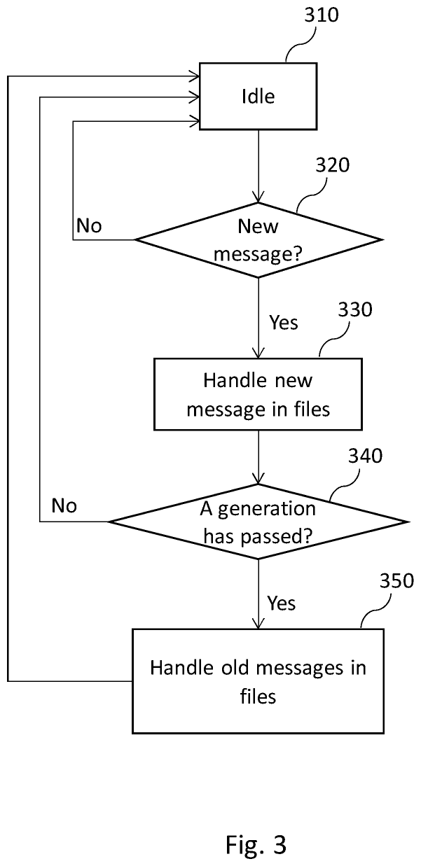

FIG. 3, to which reference is now made, is a schematic illustration of a flow that may be implemented by message module 220 in accordance with an embodiment of the invention. Message module 220 may be waiting in an idle state in step 310. In step 320, message module 220 may evaluate if an event requiring adding a new message to the file has happened and if not, message module 220 may return to the idle state in step 310. If a new message should be added, message module 220 may move to step 330 and handle the new message. In one embodiment the new message may be appended to the file and in another embodiment a new file may be created containing all previous messages and the new one.

In step 340 message module 220 may evaluate if a generation has passed and old messages should be handled and if not, message module 220 may return to the idle state in step 310. If a generation has passed, message module 220 may move to step 350 and handle old messages. It may be noted that each message may exist in the file for a duration longer that is needed in a normal operation of client 130. Keeping the messages longer may ensure its receipt by all clients 130 taking into consideration events where a client 130 has communication or other problems preventing it from reading the file in the expected timeframe. However, after a generation which is a configured time frame, in step 350, message module 220 may delete old messages to prevent the file from growing excessively and may return to the idle state in step 310.

It may be noted that message module 220 may be activated when a time has elapsed or when another configurable event happened and handle old messages even when there are no new messages.

Message module 220 may also be activated manually (by an operator or an administrator for example) to prepare the client to a burst of messages by resuming the rate to a higher frequency of read operations. For example, in an application that provide polls related to a football game, the polls may be executed in the break, and an operator activating the application may want to alert the clients prior to the actual sending of the poll. In this case, message module 220 may add a “prepare” message or may update the metadata to update the client accordingly.

Client management module 230 may be configured to evaluate the number of clients 130 using the service and maintain an adequate number of files to serve all clients 130.

The number of reads per second of a file in network file store 110 may be limited therefore each file in network file store 110 may support a specific number of clients 130. For example, AWS cloud file storage supports up to 6000 reads per second, therefore a single file can concurrently server 6000 clients 130 but when the number of clients 130 exceeds that number, i.e., 10,000, a single file can no longer provide the needed functionality and an additional file should be created to handle the excess clients 130. When there are several files, each group of clients 130 may access one of the files and client management module 230 may be configured to divide the load over the files to handle all clients 130.

Client management module 230 may be configured to evaluate the number of clients 130 using dynamic file-based publish-subscribe system 100 at a given time and ensure that network file store 110 may concurrently support all of them by storing enough files to support all read operations of clients 130. When a file in network file store 110 supports X clients 130, client management module 230 may ensure that the number F of files is at least the ceiling of the result of a division operation between the number of active clients and the number of reads supported by a single file (the rounded up nearest integer of the division result).

In one embodiment client management module 230 may evaluate the number of clients 130 using the handshake procedure. Client management module 230 may receive each handshake request, implying a client 130 is connecting to the service provided by dynamic file-based publish-subscribe system 100, and manage a counter C of the received requests, and assign each new client 130 to a group. Client management module 230 may assign a dedicated file for each group of X clients 130 and may embed the group number in the file name to enable each client 130 to access the file assigned to his group.

In another embodiment, dynamic file-based publish-subscribe system 100 may evaluate the number of clients 130 using an “active-user” API to evaluate the number C of active clients 130.

Client management module 230 may listen to “active-user” calls and perform a computation to evaluate the number of clients 130, based on a predefined probability computation. For example, the evaluation factor (sent to clients 130 in the metadata) may be used by each client 130 to decide whether to call the “active-user” API (as described herein below). Client management module 230 may count the calls received and using the evaluation factor evaluate the number of active users 135. The number of received “active-user” messages multiplied by the evaluation factor may provide a statistically good estimation of the number of clients 130 that are actively using the system.

When the number of active users 135 exceeds the number of files currently managed in network file storage 110, client management module 230 may create and store additional copies of the file.

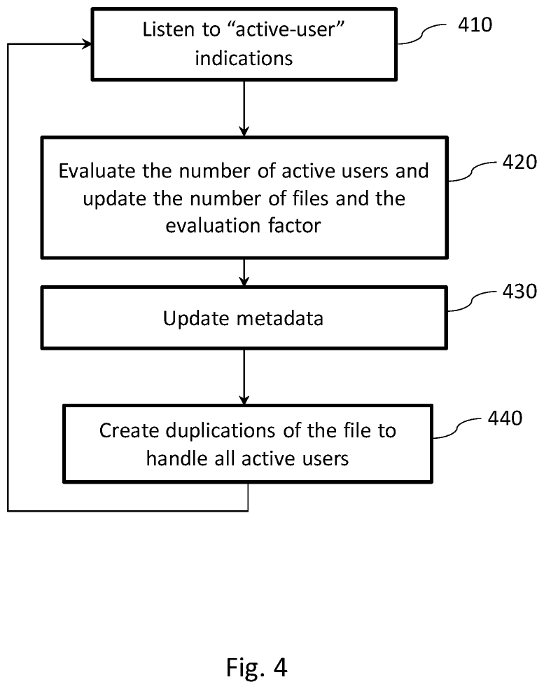

FIG. 4, to which reference is now made, is a schematic illustration of a flow that may be implemented by client management module 220 to evaluate the number of active users 135 in accordance with an embodiment of the invention.

Client management module 220 may start in step 410 listening to “active-user” indications (e.g., handshake, “active-user” API call). In step 420, client management module 220 may evaluate the number of active users 135 and may update the parameters related to the number of files and the evaluation factor accordingly. In step 430, client management module 220 may update the metadata and in step 440 client management module 220 may create several copies (duplications) of the file, each with a unique name to support all active users 135 and store them in network file store 110.

File management module 240 may be configured to update the metadata to reflect the current state of server 120 and maintain enough copies of the file to support all active clients 130.

File management module 240 may create several copies of the file according to the number of active clients 130, the name of each copy may contain a number. For example, the file name may have a unique suffix indicating its serial number. For example, 4 copies of the file may have the names XXXX-1, XXXX-2, XXXX-3 and XXXX-4.

File management module 240 may update the value of the “number of files” parameter and all other parameters related to the files in the metadate to reflect the current state of the files.

File management module 240 may compress and/or encrypt the file and may change the authentication key every configurable time. When encryption is required, file management module 240 may manage authentication keys and update the information related to the old and the new authentication keys in the metadata. File management module 240 may also provide an API through which clients 130 may retrieve the keys (e.g., to handle cases where client 130 lost connectivity for a while and did not retrieve the latest keys).

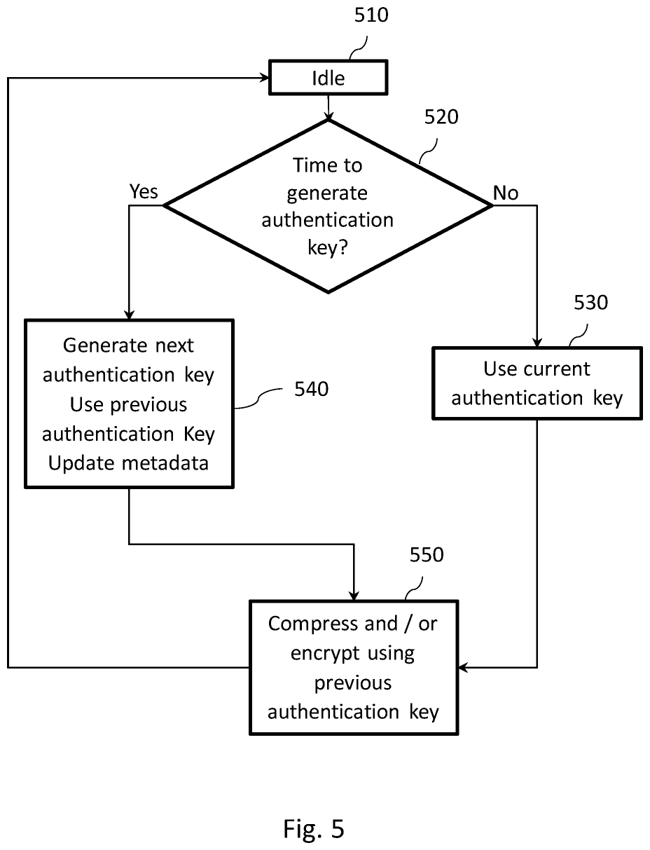

FIG. 5 to which reference is now made, is a schematic illustration of a flow that may be implemented by file management module 240 to ensure the security of the files.

File management module 240 may start in an idle state in step 510. In step 520 file management module 240 may check if a new authentication key should be generated. If there is no need to generate a new authentication key, file management module 240 may in step 530 use the current authentication key for encryption and if it is time to change the authentication key, file management module 240 may continue to step 540 and generate a new authentication key and use the previous authentication key for current operation to encrypt the file and update the metadata. In step 550, file management module 240 may compress and/or encrypt the file using the current authentication key and return to the idle state in step 510.

File management module 240 may include in the metadate additional information to enable clients 130 to change the key in due time. For example, each time the file is written and or updates, a version may be written to a parameter in the metadata and when a key is to be changed, an additional parameter may point to the version where the new key will be used.

File management module 240 may update various metadata parameters to reflect the current state, such as the evaluation factor, that depends on the known number of active users 135 and is used to improve the evaluation of the number of active clients 130. For example, if there are a couple of hundred active users 135, the evaluation factor may be 100 and if there are a couple of thousands active users 135 the evaluation factor may be 1000. Using an evaluation factor 1000 may fail to provide a meaningful result when there are a couple of hundred active users 135, while when there are hundreds of thousands of active users 135, keeping the evaluation factor low may end with a load of “active-users” API calls that is unwanted and not required to get a good enough evaluation of the number of active users 135.

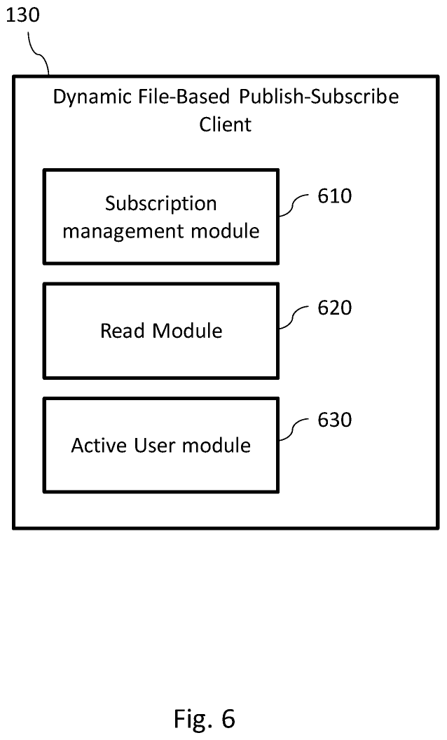

FIG. 6, to which reference is now made, is a schematic illustration of client 130 constructed and operative in accordance with an embodiment of the invention. Client 130 may be implemented in a computer software and may be running on a device capable of communicating over the internet such as a smart TV, a smart phone, laptop and the like and may comprise various modules configured to perform its functionality.

In one embodiment, client 130 comprises a subscription management module 610, a read module 620 and an active user module 630.

Subscription management module 610 may be configured to send a subscribe request to server 120 and receive the information provided by server 120 in the handshake procedure. The received information may include a file name prefix that may be used to create the name of the file to read, a first authentication key to open the file, a read frequency—the initial rate for reading the file, an evaluation factor (to assist the server in evaluating the number of users 135 actively using client 130) the number of files currently handled by server 120 and any other piece of information needed to enable client 130 to read the relevant files from the server in the desired initial rate and assist server 120 to manage the files in network file store 110.

In one embodiment subscription management module 610 may be configured to send an unsubscribe message to inform server 120 when leaving the service. This message may be used by server 120 to manage files in network file store 110.

Read module 620 may be configured to generate a file name using information provided during the handshake procedure or in the metadata of a file previously read and read the file from network file store 110 at the required rate.

In one embodiment, read module 620 may build the file name from the “file name prefix” received in the handshake and a number that may be randomly generated in the range of the number of files (indicated by the “number of files” field in the first handshake or the metadata).

In another embodiment, read module 620 may build the file name from the “file name prefix” and a group identifier provided by the server in the handshake procedure. In this case, the file name may be generated once and used throughout the entire subscription.

For example, when clients are assigned to groups (the group id may be passed to each client 130 in the handshake process) those assigned to group 1 may read file XXXX-1, those assigned to group 2 may read file XXXX-2 etc.

Read module 620 may read new messages from the file and ignore old messages already read in previous read operations using the timestamp and the message identifier associated with each message in the file.

Read module 620 may update its states and parameters according to the information received in the metadata in the file, and according to its state and may dynamically adjust the file reading rate accordingly.

The client state may depend on client 130 activity and the operation performed by user 135 on a device on which client 130 is installed.

The read rate may be controlled by client 130 and by server 120. Client 130 may consider the number of messages in the file, the functionality of user 135 and its own state when determining the time interval. The read rate may also be controlled by server 120 by the existence and the value of various parameters written by server 120 into the metadata part of the file, read by client 130.

Read module 620 may control the read rate based on user's activity and client-side events. User 135 activity may for example be writing messages, selecting products, scrolling an application or opening a specific page in a web application, such as a shopping cart or messaging application. In these cases, read module 620 may decrease the time interval, to enable receiving messages from server 120 at a higher frequency.

An event that may have an impact on the read rate may for example be a change of focus. When the application using client 130 is in focus the time interval between consecutive reads may be increased and when the application is out of focus, the time interval may be decreased. Read module 620 may control the read rate according to the number of messages in the file. If there are no messages in the file, client 130 may increase the time interval between reads according to configurable values or formulas as described herein below up to the maximum value. Read module 620 may also decrease the time for the next read, up to the minimum value, according to the number of messages in the file, and/or the value of various parameters in the metadate (including the ones initiated by the operator to prepare the client for a burst of messages).

Server 120 may instruct clients 130 to decrease the interval to be prepared for messages by adding a special message or setting specific values in the metadata or setting a specific read rate function to better control the changes in the read rate.

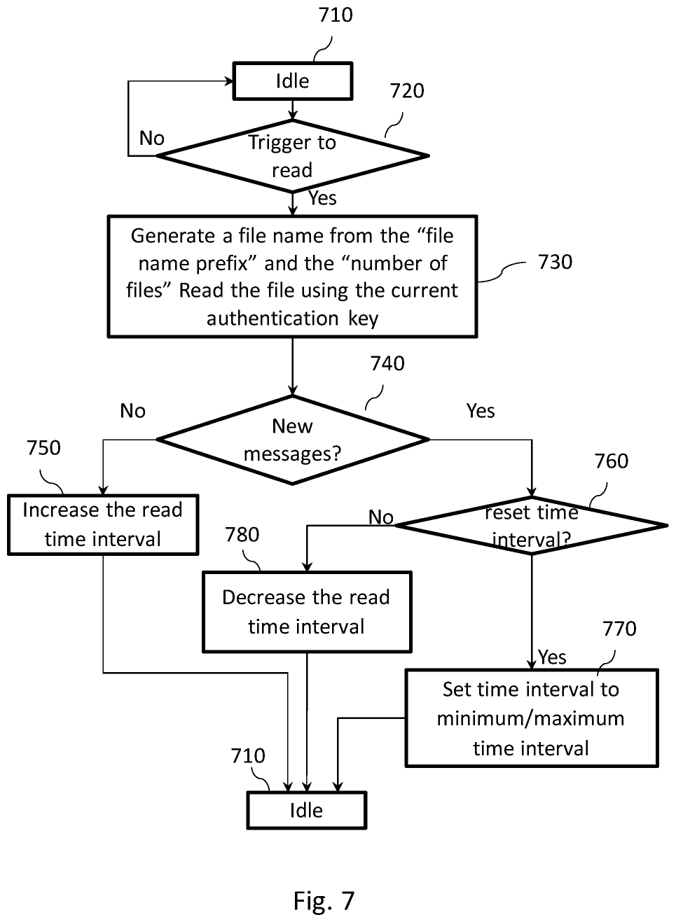

FIG. 7, to which reference is now made, is a schematic illustration of a flow that may be implemented by read module 620 to control the read rate and the time interval between consecutive reads in accordance with an embodiment of the invention.

In step 710, read module 620 may be in an idle state waiting for the time to perform a read operation. In step 720 read module 620 may check if a trigger has been detected. The trigger may be a timer event implying that a required time interval has elapsed, an activity performed by user 135 that may change the state of client 130 such as change of focus, opening a specific application, selecting a specific tab in an explorer, moving the location of a cursor or performing any gesture that can be detected by an application operating client 130 and the like. If no trigger has been detected, return to the idle state in step 710. If the time has elapsed, read module 620 may proceed to step 730 and use the information received in the metadata of a previously read file or during the handshake to generate a filename and read it from network file store 110. In step 740 read module 620 may check the number of new messages in the file. If there are no new messages read module 620 may continue to step 750 and increase the read time interval and then return to the idle state in step 710. The information in the file may include different parameters to use in different states and read module 620 may use the parameter relevant to the state of client 130.

It may be noted that for the clarity of the flow illustration, step 710 appears twice once at the top of the drawing and once at the bottom—but this is the same step.

If the file contains new messages, read module 620 may continue to step 760 and check if the time interval should be reset to its minimum or maximum values, and if so, continue to step 770 and reset the read interval to the minimum/maximum value after which read module 620 may return to the idle state in step 710. If the read interval should be gradually decreased, read module 620 may decrease the time interval in step 780 using the appropriate parameters according to the state of client 130 and return to the idle state in step 710.

The algorithms to increase or decrease the time interval between consecutive read operation of client 130 may be determined by server 120 using the parameters of the metadata in the file. The parameters may include fixed values and may be combined with functions to be used by the client to compute the time intervals between reads.

In one embodiment the time interval may be controlled by a function. The function may be linear, polynomial, exponential, logarithmical and any other function that can be used to increase and/or decrease the time interval.

As mentioned herein above, in one embodiment, server 120 may assess the number of active users 135 based on the number of “active-user” API calls it receives from clients 130, and in this case client 130 may be configured to occasionally send an “active-user” message.

Each time interval, at a certain probability, the client may send an “active-user” message to server 120. The probability that a client 130 will send a message may depend on parameters provided by server 120 in the file or during the handshake and is designed to enable estimating the total number of active users 135 from the obtained sample.

Active user module 630 may generate a random number in a specified range (between 0 and the value of the evaluation factor) and if the generated number has a predefined value, client 130 may send an “active-use” message to server 120. This procedure may provide a mechanism to reduce the number of messages sent to server 120 while providing a statistically good enough assessment of the number of active clients 130.

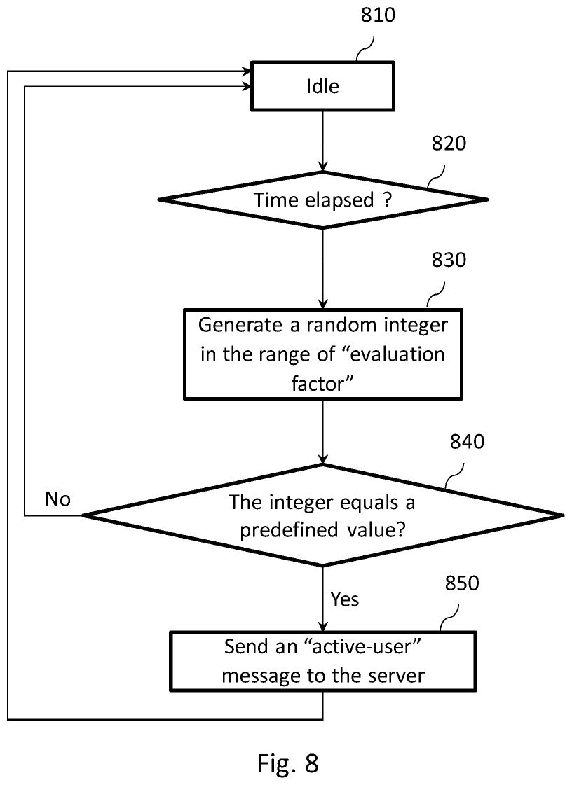

FIG. 8, to which reference is now made, is a schematic illustration of a flow that may be implemented by active user module 630 to inform server 120 about the subscription state, in accordance with an embodiment of the invention.

Active user module 630 may start in an idle state in step 810. In step 820, active user module 630 may evaluate if the time to send the “active-user” message has arrived. If not, active user module 630 may return to the idle state in step 810. If the time has arrived, active user module 630 may proceed to step 830 and generate a random integer in the specified range (the range of the “evaluation factor” parameter). In step 840, active user module 630 may check if the integer equals a predefined value and if not active user module 630 may return to the idle state in step 810 without sending the message. If the value equals the predefined value, active user module 630 may continue to step 850 and send an “active-user” message to server 120. It may be noted that if the range is 0-1000, each client 130 will statistically send an “active-user” message once in 1000 iterations (and server 120 may multiply the received messages by the “evaluation factor” to assess the number of active users).

Dynamic file-based publish-subscribe system 100 may control the number of the calls by changing the value of the “evaluation factor” to fit the number of active users at a given time, minimizing the network traffic while keeping the assessment of the number of users accurate enough.

Embodiments of the invention provide a reliable file-based communication framework, applicable for near-real time application which may reduce the cost of operation of applications operating in a public cloud when real-time expensive communication is not required for proper functionality. The time interval between consecutive reads is dynamically controlled and updated according to the needs at a given moment and may further reduce network overhead and cost.

It may be appreciated that the steps shown for the flows herein above are not intended to be limiting and that each flow may be practiced with variations. These variations may include more steps, less steps, changing the sequence of steps, skipping steps, among other variations which may be evident to one skilled in the art.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

Unless specifically stated otherwise, as apparent from the following discussions, it is appreciated that throughout the specification discussions utilizing terms such as “analyzing”, “processing,” “computing,” “calculating,” “determining,” “detecting”, “identifying” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

What is claimed is:

1. A method for controlling data read operations, the method comprising:
performing at a first point in time a first read operation to read any portion of a file stored on a data storage device;
determining a time interval based on the read portion; and
performing, responsive to the time interval having elapsed from the first point in time, a second read operation to read any portion of the file.

2. The method of claim 1 wherein the read portion comprises a formula for computing the time interval between a predefined minimum value and a predefined maximum value, and wherein the determining comprises computing the time interval using the formula.

3. The method of claim 1 wherein the determining further comprises detecting a trigger and reducing the time interval to a predefined minimum value.

4. The method of claim 3 wherein the performing and determining steps are implemented by an application operated by a user, and the trigger is a detectable action performed by the user, wherein the action is any of opening the application, selecting a specific activity in the application, changing a focus of the application, and performing a gesture detectable by the application.

5. The method of claim 1 wherein the performing step comprise:
generating a name of the file to read in the second read,
wherein the data storage device stores a number of copies of the file, each copy with a different name, and
wherein the generating step generates the name of a specific copy of the file.

6. The method of claim 5 wherein the generating further comprises:
creating a random number between 0 and the number of copies, the number of copies taken from the read portion, and
using the random number in the generating step,
wherein a name of each copy includes a unique number identifying the specific copy.

7. The method of claim 1 and further comprising:
generating a random number between 0 and an evaluation factor number provided in the read portion; and
activating an application programming interface (API) if the random number equals a predefined value, wherein a number of times the API is activated in a predefined period of time is used to estimate a number of required copies.

8. A system comprising:
a network file storage device to store a number of copies of a file, each copy with a different name; and
a client implemented on at least one processor and memory wherein the processor is configured to:
perform at a first point in time a first read operation to read any portion of one of the copies of the number of copies of the file,
determine a time interval based on the read portion, and
perform, responsive to the time interval having elapsed from the first point in time, a second read operation to read any portion of one of the copies of the number of copies of the file.

9. The system of claim 8 wherein the read portion comprises a formula for computing the time interval between a predefined minimum value and a predefined maximum value, and wherein the determining comprises computing the time interval using the formula.

10. The system of claim 8 wherein the processor is further configured to detect a trigger and reduce the time interval to a predefined minimum value.

11. The system of claim 10 wherein the client is associated to an application operated by a user, and the trigger is a detectable action performed by the user, wherein the action is any of opening the application, selecting a specific activity in the application, changing a focus of the application, and performing a gesture detectable by the application.

12. The system of claim 8 wherein the processor is further configured to generate a name of the file to read in the second read using the read portion.

13. The system of claim 12 wherein a name of each copy includes a unique number identifying the specific copy and wherein the processor is further configured to create a random number between 0 and the number of copies, the number of copies taken from the read portion, and use the random number to generate the name.

14. The system of claim 8 and wherein the processor is further configured to:
generate a random number between 0 and an evaluation factor number provided in the read portion, and
activate an application programming interface (API) if the random number equals a predefined value, wherein a number of times the API is activated in a predefined period of time is used to estimate the number of required copies.
